(19) United States
(12) Patent Application Publication
(10) Pub. No.: US 2023/0136175 A1
(43) Pub. Date: May 4, 2023

(54) PUMP AND MOTOR VEHICLE HAVING AT LEAST ONE SUCH PUMP

(71) Applicant: Vitesco Technologies GmbH, Regensburg (DE)

(72) Inventors: Johannes DEICHMANN, Munich (DE); Andreas SCHMICK, Munich (DE); Wolf GOETZE, Munich (DE)

(21) Appl. No.: 18/051,945

(22) Filed: Nov. 2, 2022

(30) Foreign Application Priority Data
Nov. 3, 2021 (DE) 10 2021 212 381.3

(51) Int. Cl. H02K 5/20; H02K 9/193

(52) U.S. Cl. CPC H02K 5/203; H02K 9/193

(57) ABSTRACT

A pump for delivering a liquid, having an electric motor with a stator and a rotor arranged inside the stator. The electric motor is accommodated in an electric motor housing. The stator has two end faces and an outer peripheral surface and there is formed between the electric motor housing and the outer peripheral surface of the stator an outer fluid channel through which the liquid can be delivered. The stator has on at least one of its end faces a connection to the electric motor housing.

### BACKGROUND OF INVENTION

### 1. Field of the Invention

The disclosure relates to a pump for delivering a liquid, having an electric motor which has a stator and a rotor arranged inside the stator, the electric motor is accommodated in an electric motor housing, the stator has two end faces and an outer peripheral surface, and there is formed between the electric motor housing and the outer peripheral surface of the stator an outer fluid channel through which the liquid can be delivered. The disclosure furthermore relates to a motor vehicle having at least one pump of said type.

### 2. Description of Related Art

Publication DE 10 2009 028 266 A1 discloses a pump having an electric motor, which has a stator and a rotor arranged inside the stator, wherein the stator is accommodated in an electric motor housing. Between the stator and the electric motor housing there are arranged individual fluid channels that are spaced apart from one another in the peripheral direction of the stator and fluidically separated from one another by supporting portions. The supporting portions are formed by portions of the stator on which the electric motor housing is radially supported.

Publication US 2010 054 972 A1 likewise discloses a pump having an electric motor which has a stator and a rotor arranged inside the stator. Here too, fluid channels are formed, which are spaced apart from one another in the peripheral direction of the stator and separated from one another by supporting portions.

A disadvantage of the apparatuses of the prior art is in particular that, owing to the supporting portions, the flow cross-section of the external fluid channels is limited and undesirable flow losses thus occur. Furthermore, the outside diameter of the electric motor housing would have to be made larger to increase the flow cross-sections and thus reduce the flow losses, which would entail disadvantages in respect of the required installation space. Specifically in the case of pumps, which are arranged inside a tank, larger dimensions of a pump of said type result in there being an increasingly large partial volume of the tank that cannot be used to accommodate liquid. Furthermore, owing to the supporting portions, the delivery stream is distributed non-uniformly at the outer peripheral surface of the stator, which causes non-uniform cooling of the stator.

### SUMMARY OF THE INVENTION

An object of one aspect of the present invention is to provide a pump distinguished by low flow losses, uniform cooling of the stator, and small dimensions. Furthermore, another object consists in providing a pump distinguished by a simple and inexpensive construction. Another aspect consists in providing a motor vehicle having at least one pump of said type.

The aspects relating to the pump are achieved by a pump mentioned at the beginning, which is distinguished in that the stator has at at least one of its end faces a connection to the electric motor housing. In other words, the stator is connected at at least one of its end faces to the electric motor housing by a connection.

By providing a connection between the electric motor housing and the stator at an end face of the stator, a connection of said type between the electric motor housing and the stator at the outer peripheral surface of the stator can be dispensed with, as a result of which it is possible to increase the flow cross-section with a given outside diameter of the electric motor housing. This leads, on the one hand, to a small outside diameter of the electric motor housing and at the same time to a large flow cross-section, which is accompanied by low flow losses. Because supporting portions on the outer peripheral surface of the stator are thus not required, the delivery stream is likewise distributed uniformly at the outer peripheral surface of the stator and thus the stator is cooled uniformly.

It is particularly advantageous if a connection of the stator to the electric motor housing is formed only at one of the end faces of the stator or only at the two end faces of the stator. In other words, a connection of the stator to the electric motor housing at the outer peripheral surface, which would lead to a narrowing of the flow cross-section of the outer fluid channel, is excluded by such a configuration.

It is advantageous if the connection is a direct or indirect connection between the stator and the electric motor housing. In other words, it is possible that the stator is connected to the electric motor housing by a connection without an intermediate element or with an intermediate element. Connected indirectly or with an intermediate element means connected by way of a further component, that is to say by way of a further component. It is advantageous if the further component, which is used for the indirect connection between the stator and the electric motor housing, is a component of the pump, for example a pump stage housing, a holder that has a bearing for a rotor shaft of the electric motor, or an end cap that has a fluid outlet and/or an electrical plug connector. In other words, it is preferred if there is used for the indirect connection of the stator to the electric motor housing a component of the pump that at the same time serves another purpose or fulfills a further function. In this manner, the number of necessary components for the pump according to one aspect of the invention is kept low, which keeps the outlay in terms of installation and the costs low.

It is furthermore advantageous if the connection is a fastening. In other words, the connection between the stator and the electric motor housing is a fastening between the stator and the electric motor housing. That is to say, the fastening is preferably dimensioned such that the stator is fixed inside the electric motor housing. It is preferred if the fastening is an interlocking, substance-to-substance and/or force-based fastening. For example, it is advantageous if the stator is clamped, in particular axially clamped, between two structural elements of the pump. Preferably, one of these two structural elements is a pump stage housing or part of a pump stage housing, which is arranged at a first end face of the stator. Alternatively, it is the holder mentioned above. It is furthermore preferred if the further structural element is an end cap, which is arranged at a second end face of the stator. The end cap is preferably configured such that it has at least one fluid outlet to which there can be connected a fluid line for the liquid to be delivered by the pump. It is furthermore preferred if the end cap has an electrical connector to which there can be connected an electrical line for supplying power to the electric motor. In other words, it is preferred if the electrical connector is in electrically conducting connection with a winding of the stator. It is additionally particularly preferred if the end cap is formed of a plastics material, because this electrically insulates the electrical connector with respect to the surroundings. It is advantageous if the end cap and/or part of the pump stage housing is formed in one piece with an overmold of the stator. The outlay in terms of installation can thereby be reduced considerably. Preferably, the stator, inside the electric motor housing, is directly or indirectly fastened to the electric motor housing or fixed in the electric motor housing at only one of its end faces or at both end faces.

The first end face of the stator is preferably a stator end that faces the pump stage. The second end face of the stator is preferably a stator end that faces the end cap or a fluid outlet and/or that is remote from the pump stage. In principle, the two end faces of the stator are located at two opposite ends of the stator in the longitudinal direction of the stator. Longitudinal direction means the direction in which an axis of rotation of a rotor arranged in the stator extends.

In particular, a stator of said type has only two faces, which are remote from one another, and an outer peripheral surface. In other words, the basic shape of the stator preferably corresponds to the shape of a cylinder, wherein the stator in particular has a recess for accommodating a rotor, wherein the accommodating recess extends along the longitudinal axis of the stator from one of the end faces to the other end face.

In a further preferred embodiment, at least part of the electric motor housing or the entire electric motor housing is in the form of a sheet-metal jacket which, at each end face of the stator, engages behind a component of the pump or an edge of a component of the pump such that a clamping force acts on the stator of the electric motor and the stator is thereby fastened to the electric motor housing. The components of the pump are preferably part of the pump stage housing, the pump stage housing and/or the end cap. In particular, these components close the electric motor housing in the axial direction, that is to say in the direction of extension, i.e. the longitudinal axis, of the rotor shaft.

It is particularly advantageous if a fastening of the stator to the electric motor housing is formed only at one of the end faces of the stator or only at the two end faces of the stator. In other words, a fastening of the stator to the electric motor housing at the outer peripheral surface, which would lead to a narrowing of the flow cross-section of the outer fluid channel, is excluded by such a configuration. In other words, a fastening of the stator consists only of a fastening at at least one of the two end faces.

One exemplary aspect of the invention is characterized in that a, the, or each connection of the stator to the electric motor housing is arranged spaced apart from a or from the outer fluid channel. In particular when the pump has only an outer fluid channel, the connection of the stator to the electric motor housing is thereby prevented from reducing the flow cross-section of the outer fluid channel. In other words, a low flow resistance is thereby achieved.

A further aspect of the invention is characterized in that the connection of the stator to the electric motor housing is arranged spaced apart from the outer peripheral surface. By arranging the connection of the stator to the electric motor housing spaced apart from the outer peripheral surface of the stator, it is ensured that the connection does not cause a narrowing of the cross-section of the outer fluid channel which is located between the electric motor housing and the stator. A loss of flow as a result of a narrowing of the cross-section is thereby avoided.

Another exemplary aspect of the invention is characterized in that the electric motor housing is arranged spaced apart from the outer peripheral surface of the stator. In this manner, the outer fluid channel can be formed relatively easily by the spacing apart of the electric motor housing from the outer peripheral surface of the stator.

Another aspect of the invention is characterized in that the outer fluid channel is defined by the outer peripheral surface of the stator and the electric motor housing. In other words, the outer fluid channel is defined in the radial direction, that is to say transverse or perpendicular to the longitudinal axis of the stator or the axis of rotation of the rotor accommodated in the stator, on the one hand by the electric motor housing and on the other hand by the stator. An extremely direct thermal connection of the fluid to be delivered through the outer fluid channel with the stator and also with the electric motor housing is thereby ensured. In particular the thermal connection of the fluid to be delivered with the stator that is thereby implemented serves for the cooling of the stator during operation of the pump. In this manner, the pump according to one aspect of the invention can be operated at its performance limit in continuous operation without the expectation of failure or a defect of the pump as a result of overheating. At the same time, additional components such as tubes or hoses for forming the outer fluid channel can be dispensed with, which keeps the outlay in terms of installation and the costs low.

Another exemplary aspect of the invention is characterized in that the outer peripheral surface of the stator is formed by a plastics overmold of the stator. The stator can thereby be protected from the fluid to be delivered. In particular when the liquid to be delivered is fuel, the fuel to be delivered can attack the material of which the stator is manufactured, which can be avoided by a corresponding plastics overmold of the stator. Preferably, the plastics material in such a case is a plastics material which is resistant to fuel. Furthermore, the flow resistance of the outer fluid channel can be reduced further by a plastics overmold of the stator because, as a result of the plastics overmold, the outer peripheral surface of the stator has a smoother surface compared to the stator without the plastics overmold and therefore causes less turbulence of the flow. In addition, it is possible in another embodiment that the plastics overmold of the stator, together with a further component of the pump, forms an element for centering of the stator in the electric motor housing. Such a centering element is preferably formed at at least one end face of the stator.

Another aspect of the invention is characterized in that there is formed between the stator and the rotor an inner fluid channel through which the liquid can be delivered. By further forming a fluid channel that extends inside the stator, between the stator and the rotor, the cooling effect of the liquid to be delivered on the stator winding, the stator and the rotor can be increased further, wherein the flow cross-section is increased further compared to an embodiment which has only an outer fluid channel, while the outside diameter of the electric motor housing remains the same. Very particularly preferably, the narrowest cross-section of the flow cross-section of the outer fluid channel is at least five times, in particular at least ten times, the largest cross-section of the flow cross-section of the inner fluid channel. It is thereby ensured, on the one hand, that a sufficiently great flow of liquid through the inner fluid channel is available for cooling the rotor, and on the other hand it is thereby ensured, above all, that the total flow cross-section, consisting of the two flow cross-sections of the inner and outer fluid channels, corresponds to a value which causes as low a flow loss as possible. In particular, the outer fluid channel and the inner fluid channel extend parallel to one another in the direction towards a fluid outlet of the pump.

Another exemplary aspect of the invention is characterized in that the outer fluid channel is in the form of an annular passage. It is particularly preferred if the annular passage has a constant annular passage height in the peripheral direction of the stator. It is very particularly preferred if the annular passage height is constant along the extent of the outer fluid channel parallel to the longitudinal axis of the stator. The annular passage height means the distance between the outer peripheral surface of the stator and the electric motor housing in the radial direction, that is to say transverse, in particular perpendicular, to the longitudinal axis of the stator or the axis of rotation of the rotor accommodated in the stator, in particular when the outer fluid channel is defined by the electric motor housing and the outer peripheral surface of the stator. It is additionally particularly preferred if the annular passage extends through 360° around the stator or the axis of rotation of the rotor accommodated in the stator.

Another aspect of the invention is characterized in that the annular passage extends over at least 80% of the length of extension of the stator, preferably over the entire length of extension of the stator. It is very particularly preferred if the annular passage extends wholly along its parallel extent to the axis of rotation of the rotor.

Another exemplary aspect of the invention is characterized in that the pump is in the form of a fuel pump. An extremely compact fuel pump which has a high degree of efficiency and is distinguished by a uniform cooling effect is thereby provided.

Another aspect of the invention is characterized in that the pump is in the form of an oil pump or in the form of a coolant pump. An extremely compact oil pump or coolant pump which has a high degree of efficiency and is distinguished by a uniform cooling effect is thereby provided.

The object relating to the motor vehicle is achieved in that a motor vehicle having at least one pump according to one aspect of the invention is provided.

A motor vehicle having an extremely compact pump and particularly low energy consumption for operating that at least one pump is thereby provided. Another aspect of the invention is characterized in that a motor vehicle having a fuel pump according to the invention, a coolant pump according to the invention and/or an oil pump according to the invention is provided. A motor vehicle which has extremely low energy consumption for supplying lubricating oil, for supplying coolant and for supplying fuel to a combustion engine is thereby provided.

Advantageous refinements of the present invention are described in the dependent claims and in the following description of the figures.

### BRIEF DESCRIPTION OF THE DRAWINGS

The invention will be explained in detail below on the basis of an exemplary embodiment and with reference to the drawings. In the drawings:

FIG. 1 is a sectional view of a pump; and

FIG. 2 is another sectional view of the pump from FIG. 1.

### DETAILED DESCRIPTION OF THE PRESENTLY PREFERRED EMBODIMENTS

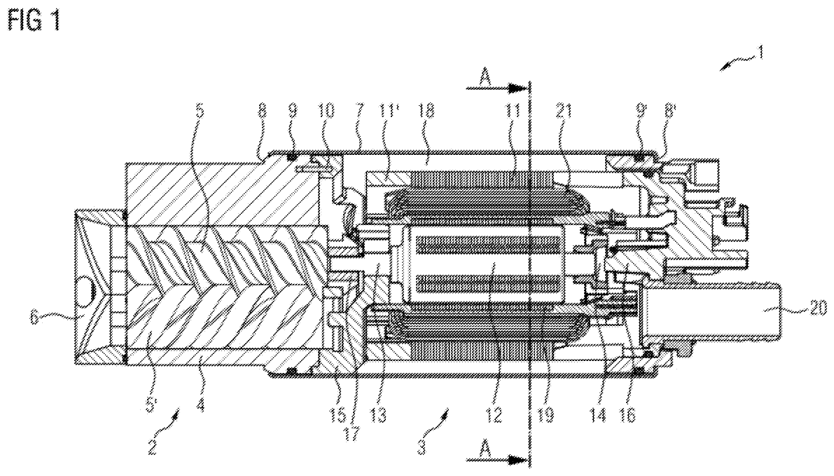

FIG. 1 shows a sectional view of a pump 1 according to one aspect of the invention, which is in the form of a fuel pump. The pump 1 has a pump stage 2 and an electric motor 3. The pump stage 2 comprises a pump stage housing 4, which has an intake region 6 through which a liquid to be delivered, in this case fuel, can be drawn by suction from a tank. A first spindle 5 and a second spindle 5′ are accommodated in the pump stage housing 4. The first spindle 5 is in drive connection by way of a coupling 17 with a shaft of a rotor 12 of the electric motor 3 and can thus be driven by the electric motor 3. The second spindle 5′ can be driven by the rotation of the first spindle 5. The rotor 12 is rotatably arranged inside the stator 11 of the electric motor 3. The shaft of the rotor 12 is rotatably mounted in a first rotor shaft bearing 13 and a second rotor shaft bearing 14. The second rotor shaft bearing 14 is formed in one piece with an end cap 16, which has a fluid outlet 20 in the form of a connecting piece. Furthermore, the end cap has been produced from plastics material in a single plastics injection molding process. The first rotor shaft bearing 13 has likewise been produced from plastics material by plastics injection molding. The first rotor shaft bearing 13 is additionally integrated in a holder 15. The holder 15 is arranged between the pump stage housing 4 and the stator 11, which has a plastics overmold 11′. Furthermore, the holder 15 has three supporting arms supported on the pump stage housing 4. The three supporting arms extend from the first rotor shaft bearing 13 in the direction towards the pump stage housing 4 and are thereby offset by 120° relative to one another in the peripheral direction, that is to say in the peripheral direction based on the axis of rotation of the rotor 12, so that a liquid to be delivered, in this case fuel, can be delivered from the pump stage housing 4 to an outer fluid channel 18. The outer fluid channel 18 extends over the entire length of extension of the stator 11 substantially parallel to the axis of rotation of the rotor 12 of the electric motor 3. The outer fluid channel 18 is thereby defined by the plastics overmold 11′ of the stator 11 and an electric motor housing 7, which is in the form of a sheet-metal jacket. The electric motor housing 7 in the form of a sheet-metal jacket extends from a first body edge 8, which belongs to the pump stage housing 4, to a second body edge 8′, which belongs to the end cap. The electric motor housing 7 engages behind both the first body edge 8 and the second body edge 8′, such that the pump stage housing 4 and the end cap 16 are biased against one another. Because the stator 11 on the one hand is supported by its plastics overmold 11′ on the end cap 16 and on the other hand is supported on the holder 15, wherein the holder 15 is in turn supported on the pump housing 4, the electric motor 3 is fixed in a statically determinate manner inside the pump 1 in that the stator 11 is clamped between the pump housing 4 and the end cap 16. In other words, the connection or fastening of the stator 11 to the electric motor housing 7 is effected in this exemplary embodiment by clamping of the stator 11 between the pump stage housing 4 and the end cap 16. Furthermore, the pump housing 4 has in the vicinity of the first body edge 8 a sealing element 9, which is in the form of an O-ring. In addition, the end cap 16 has in the vicinity of the second body edge 8′ a second sealing element 9′, which likewise is in the form of an O-ring. A leakage flow from the electric motor housing 7 is prevented by the two sealing elements 9, 9′. Between the holding element 15 and the pump stage housing 4 there are provided centering pins 10 for orienting the holding element 15 in a defined manner relative to the pump housing 4. In addition, there is provided between the rotor 12 and the stator 11, which has a stator winding 21, an inner fluid channel 19, the flow cross-section of which is many times smaller than that of the outer fluid channel 18. Cooling of the rotor 12 and also of the stator winding 21 of the stator 11 is ensured with the aid of the inner fluid channel 19. During delivery operation of the pump 1, the fuel to be delivered passes through the intake opening 6 into the pump stage housing 4, where it is delivered in the direction towards the electric motor 3 by the rotation of the two spindles 5, 5′. From there, the delivery stream splits into two partial delivery streams, of which a first partial delivery stream flows between the 3 supporting arms to the outer fluid channel 18 and along the electric motor housing 7 and along the stator 11 to the fluid outlet 20. The second partial delivery stream flows through openings in the holder 15 past the first rotor shaft bearing 13 into the inner fluid channel 19. From the inner fluid channel 19, the second partial delivery stream flows in the direction towards the end cap 16 to the fluid outlet 20. In other words, the two partial delivery streams come together again in the region of the end cap 16 and leave the pump 1 together from the fluid outlet 20. The fluid outlet 20 is in the form of a connecting piece to which a fluid line can be connected. FIG. 1 furthermore has a cutting line A-A.

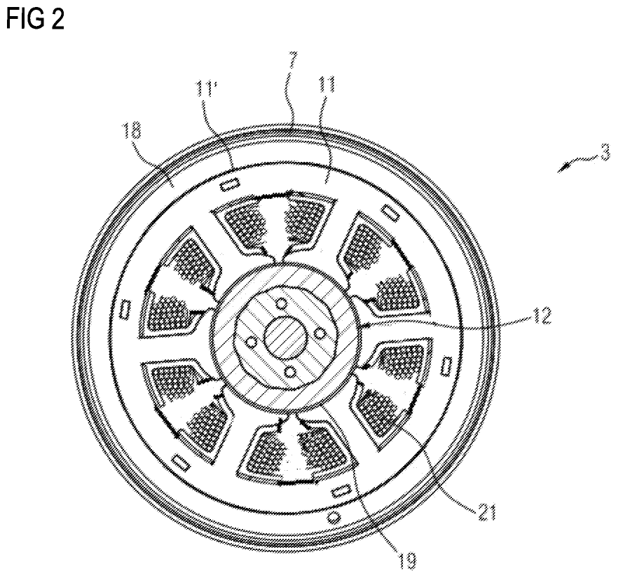

FIG. 2 shows the sectional view of the cutting line A-A through the electric motor 3 of the pump from FIG. 1. It can be seen that the electric motor housing 7 and the plastics overmold 11′ of the stator 11 define the outer fluid channel 18 in the radial direction, that is to say perpendicular to the axis of rotation of the rotor 12. Furthermore, the outer fluid channel 18 is in the form of an annular passage 18, which extends through 360° around the axis of rotation of the rotor shaft 12 and has a constant annular passage height. Uniform distribution of the first partial delivery stream, which can be delivered through the outer fluid channel 18, is thereby achieved, which results in uniform cooling of the stator and a low flow resistance. Furthermore, the stator winding 21, which is in the form of a concentrated winding, can be seen in FIG. 2. The stator winding 21 and the rotor 12 are cooled by the second partial delivery stream, which can be delivered through the inner fluid channel 19.

The exemplary embodiment of FIGS. 1 and 2 in particular does not have a restrictive character and serves merely for illustrating the concept of the invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A pump for delivering a liquid, comprising:
an electric motor, comprising:
a stator having two end faces and an outer peripheral surface; and
and a rotor arranged inside the stator;
an electric motor housing in which the electric motor is accommodated; and
an outer fluid channel formed between the electric motor housing and the outer peripheral surface of the stator through which the liquid can be delivered;
wherein the stator has on at least one of its end faces a connection to the electric motor housing.

2. The pump as claimed in claim 1, wherein the connection of the stator to the electric motor housing is arranged spaced apart from the outer fluid channel.

3. The pump as claimed in claim 1, wherein the connection of the stator to the electric motor housing is arranged spaced apart from the outer peripheral surface.

4. The pump as claimed in claim 1, wherein the electric motor housing is arranged spaced apart from an outer peripheral surface of the stator.

5. The pump as claimed in claim 1, wherein the outer fluid channel is defined by the outer peripheral surface of the stator and the electric motor housing.

6. The pump as claimed in claim 1, wherein the outer peripheral surface of the stator is formed by a plastics overmold of the stator.

7. The pump as claimed in claim 1, wherein an inner fluid channel is formed between the stator and the rotor through which the liquid can be delivered.

8. The pump as claimed in claim 1, wherein the outer fluid channel is an annular passage.

9. The pump as claimed in claim 8, wherein the annular passage extends over at least 80% of a length of extension of the stator.

10. The pump as claimed in claim 1, wherein the pump is configured as one of a fuel pump, an oil pump, or a coolant pump.

11. The pump as claimed in claim 9, wherein the annular passage extends over an entire length of extension of the stator.

12. A motor vehicle comprising:
at least one pump for delivering a liquid, comprising:
an electric motor, comprising:
a stator having two end faces and an outer peripheral surface;
and a rotor arranged inside the stator;
an electric motor housing in which the electric motor is accommodated;
an outer fluid channel formed between the electric motor housing and the outer peripheral surface of the stator through which the liquid can be delivered;
wherein the stator has on at least one of its end faces a connection to the electric motor housing.
